(19) United States
(12) Patent Application Publication
(10) Pub. No.: US 2019/0252871 A1
(43) Pub. Date: Aug. 15, 2019

(54) High-Voltage Device

(71) Applicant: SIEMENS AKTIENGESELLSCHAFT, MUENCHEN (DE)

(72) Inventors: TIM SCHNITZLER, KREUZAU (DE); JOACHIM TITZE, RATINGEN (DE)

(21) Appl. No.: 15/774,478

(22) PCT Filed: Oct. 12, 2016
(86) PCT No.: PCT/EP2016/074384

§ 371 Date: May 8, 2018

(30) Foreign Application Priority Data
Nov. 27, 2015 (DE) 102015223587.4

(51) Int. Cl. H02G 15/072

(52) U.S. Cl. CPC H02G 15/072

(57) ABSTRACT

A high-voltage device has an inner conductor and an insulating body, which surrounds the inner conductor along the longitudinal direction of the inner conductor. Electrically conductive control inserts for field control are arranged concentrically around the inner conductor and are spaced apart from each other by insulating layers. An electrically conductive connection extends between the inner conductor and a first control insert that is closest to the inner conductor. An electrically conductive connection extends between the inner conductor and a second control insert. The second control insert extends axially beyond the first control insert to a foot end of the high-voltage device.

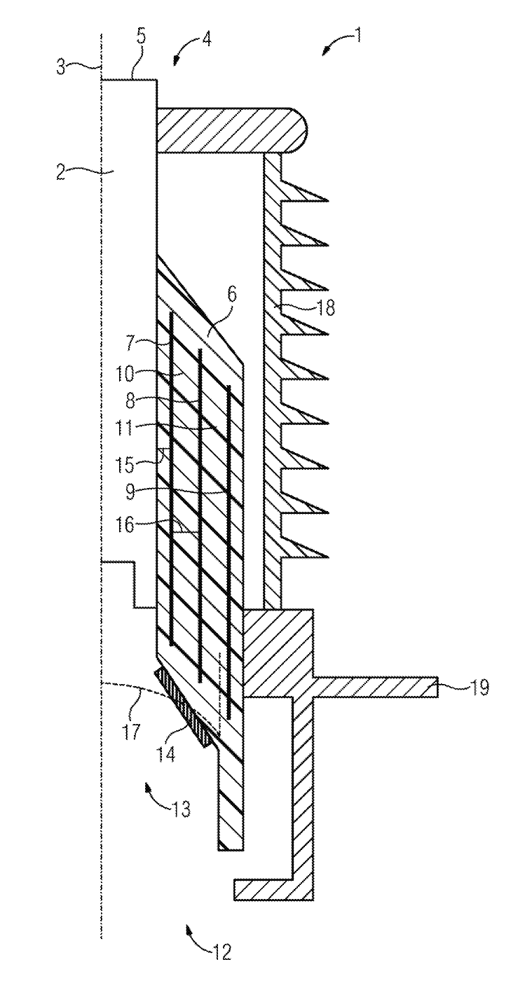

The invention relates to a high-voltage device comprising an inner conductor, an insulating body that surrounds the inner conductor along its longitudinal direction, and which comprises electrically conductive control linings for field control, which are arranged concentrically around the inner conductor and are spaced apart from each other by insulating layers, and an electrically conductive connection between the inner conductor and a first control lining closest to the inner conductor.

High-voltage devices of this kind are known from the prior art. In general, they have the task of insulating a high-voltage conductor that is at a high-voltage potential with a current-carrying cable from an environment that is essentially at ground potential.

The inner conductor of the known high-voltage device is, however, not usually ideally cylindrically symmetrical, and exhibits irregularities arising from the manufacturing process on its surface. For these reasons, the field distribution in the environment of the inner conductor is in general non-homogeneous, which can have the result of lowering the functional capability of the high-voltage device.

The necessity of electrically connecting the inner conductor to the first control lining by means of a connecting device arises from this for electrical engineering reasons. This is also referred to as making contact.

In the high-voltage device known from PCT/EP2014/059627, the connecting device is implemented by a flexible metal strap. The metal strap is fastened at one of its ends to the inner conductor and at the other end to the first control lining. The metal strap is, furthermore, tightly surrounded by an insulating medium of the insulating body.

A high-voltage device which serves as a cable end termination for connecting a cable end to an overhead line is, furthermore, known from DE 10 2012 203 712 A1. The insulating body surrounding the inner conductor comprises a recess having the form of a truncated cone opening to a plug-in contact for the cable end. The recess is provided to accept the cable end which accordingly is surrounded by a part of the insulating body. Disturbing irregularities of the electrical field distribution within the high-voltage device can occur in particular with such a construction.

The object of the invention is to propose a high-voltage device of the type mentioned at the beginning which permits the most uniform possible field distribution.

The object is achieved in a high-voltage device of the appropriate type through an electrically conductive connection between the inner conductor and a second control lining which extends axially beyond the first control lining to a foot end of the high-voltage device.

According to the invention therefore an additional conductive connection is made between the inner conductor and a further, second control lining. This means that the second control lining is also brought to the potential of the inner conductor. The second control lining extends axially beyond the first control lining to the foot end of the high-voltage device. Foot end here refers to one of the two ends of the high-voltage device extending in the longitudinal direction. The other end is usually referred to as a head end. The end of the cylindrical second control lining that faces the foot end accordingly lies closer to the foot end than the corresponding end of the first control lining. The second control lining, through the electrical connection to the inner conductor, can thus develop a screening effect with respect to a part of the high-voltage device that is not surrounded by the first control lining. As the applicant's own tests have shown, the distribution of the electrical field of the high-voltage device can be improved as a result of this screening effect. Parts of a foot fitting that is arranged at the foot end of the high-voltage device, and which usually exhibits a construction of small parts with corners and edges, and thus an unfavorable field distribution, can for example be screened by the second control lining. A relatively uniform profile of the electrical field lines can be achieved in this way even in the region of the foot fitting.

According to one form of embodiment of the invention, the insulating body comprises a recess having the form of a truncated cone opening to the foot end of the high-voltage device; the second control lining extends axially into a part of the insulating body surrounding the recess. The recess at the foot end of the high-voltage device here serves to accept a screening component. The recess can, for example, be constructed to accept the foot fitting and/or a plug-in connecting piece for connecting to a further conducting piece or to a cable end. The component is thus on the one hand partly surrounded by the insulating body. On the other hand, the component is also electrically screened in this way by means of the second control lining, because the second control lining partially surrounds the component that is arranged in the recess.

Preferably the second control lining is closest to the first control lining. Accordingly, there is no further control lining between the first and the second control lining. This simplifies the provision of the electrical connection between the two control linings. It is, however, conceivable that the second control lining is not the second in the sense of counting the control linings outwards from the inner conductor. In principle, any suitable control lining other than the first can be used as the second control lining connected to the inner conductor.

A first metal strap is preferably provided for establishing the electrical connection between the inner conductor and the first control lining. Due to its flexibility, a metal strap is particularly suitable as compared with rigid rails or bolts. Wires and straps made of metal or of another electrically conductive material are, for example, also suitable.

A second metal strap that electrically connects the first control lining to the second control lining is preferably provided. The electrical connection between the inner conductor and the second control lining is realized here by means of a connection between the first control lining, which is connected to the inner conductor, and the second control lining. This ensures a particularly simple and reliable electrical connection. Here again, instead of a metal strap, wires and straps of other electrically conductive materials can be employed. It is, of course, also conceivable for the electrical connection between the inner conductor and the second control lining to be provided separately and independently of the electrical connection between the inner conductor and the first control lining.

It is deemed to be particularly advantageous if the electrical connection between the second metal strap and the second control lining is solder less. This means that the metal strap merely lies on the second control lining without having been connected to it by soldering. This type of contacting is particularly simple, because the soldering can be omitted. This is advantageous because under some circumstances the material of the insulating body can be damaged by the soldering.

According to one form of embodiment of the invention, the recess having the form of a truncated cone is constructed to accept a conductor section of a high-voltage cable; the high-voltage device comprises a plug-in contact piece for connecting the conductor section to the inner conductor. The high-voltage device can here, for example, be a cable end termination for establishing an electrical connection between a high-voltage cable and an electrical conductor of an overhead line. In this context, the plug-in contact piece can be formed of multiple parts and be non-homogeneous. As a result of this the profile of the electrical field in the immediate neighborhood of the plug-in contact piece can, without its screening, be relatively non-homogeneous. In such a case, the screening by the second control lining is suitable for ensuring a relatively favorable profile of the electrical field there. In particular, the occurrence of partial discharges at the transfer location from the inner conductor to the plug-in contact piece can be avoided through the screening effect of the second control lining.

The plug-in contact piece can, for example, comprise contact lamella for establishing an electrical connection between the conductor section and the inner conductor and/or suitable threaded holes for fastening the high high-voltage cable to the high-voltage device.

An electrically insulating sealing layer is preferably applied to an inner surface of the recess. The sealing layer ensures that the plug-in contact piece is sealed within the recess, so that an ingress of moisture and dirt in the region of the electrical contact between the inner conductor and the conductor section of the high-voltage cable is prevented. The electrical connection between the inner conductor and the second control lining is in this case particularly advantageous, since the transfer location at the sealing layer can also be screened, so achieving a relatively uniform field distribution at this transfer location. The sealing layer can, for example, comprise silicone. Silicone can provide a particularly advantageous sealing effect.

In this context it is considered particularly advantageous if the second control lining extends axially into a part of the insulating body that surrounds the sealing layer. The second control lining thus at least partially also surrounds the sealing layer. The screening effect of the second control lining can in this way be realized particularly effectively.

According to a further form of embodiment of the invention, the insulating body comprises resin-impregnated paper. The individual control linings are thus separated from one another by insulating layers, wherein the insulating layers comprise resin-impregnated paper. Such an insulating body forms a compact block, so that in particular the first and the second control linings are constructed particularly uniformly. In this way, a relatively uniform profile of the electrical field is achieved.

The invention is explained below with reference to an exemplary embodiment illustrated in the FIGURE.

The FIGURE shows a schematic, cross-sectional view of a high-voltage device according to the invention.

In detail, according to the invention a high-voltage device 1 in the form of a cable end termination is shown in the FIGURE. The high-voltage device 1 is constructed essentially cylindrically symmetrically around a longitudinal direction 3 which forms the axis of symmetry. The high-voltage device 1 comprises a cylindrical, hollow inner conductor 2. The inner conductor 2 extends along a longitudinal direction of the high-voltage device 1, which is graphically identified by a longitudinal axis 3.

The high-voltage device 1 comprises a head end 4 with a head fitting 5 for fastening an electrical conductor of an overhead line not shown graphically in the FIGURE.

The high-voltage device 1 further comprises an insulating body 6 which surrounds the inner conductor 2 along its longitudinal direction. It can be seen that the insulating body 6 does not surround the inner conductor 2 along its entire length. This is not in fact necessary either in the exemplary embodiment of the invention illustrated in the FIGURE or in any other exemplary embodiment. The insulating body 6 comprises control linings 7, 8, 9 arranged concentrically around the inner conductor 2. The control linings 7-9 are separated from one another by insulating layers 10, 11. The insulating layers 10, 11 comprise paper which, like the entire insulating body 6, is impregnated with a resin. The insulating body 2 is surrounded by an outer housing 18 of the high-voltage device 1.

For reasons of clarity, only three control linings 7-9 are illustrated graphically in the FIGURE. The number of control linings can, however, in general be higher, and adapted to the particular application. The radial distance between the individual control linings usually amounts to a few millimeters.

The high-voltage device 1 further comprises a foot end 12 which is arranged opposite to the head end 4. A foot fitting for fastening a high-voltage cable not illustrated in the FIGURE is arranged at the foot end 12. For reasons of clarity, the foot fitting is not shown graphically in more detail on the FIGURE.

The insulating body 6 comprises a recess 13. The recess 13 has the form of a truncated cone that points with its opening end to the foot end 12. A part of an inner face of the recess 13 is covered by a sealing layer 14 of silicone. The sealing layer 14 seals a contact location between the high-voltage device 1 and the cable section of the high-voltage cable that is inserted into the recess 13.

The inner conductor 2 is electrically connected to a first control lining 7 by means of a first metal strap 15. The first control lining 7 is arranged closest to the inner conductor 2. The first metal strap 15 extends into the insulating body 6. A second control lining 8 extends to the foot end 12 further than the first control lining 7. The second control lining 8 extends in particular into the part of the insulating body 6 that surrounds the recess 13 and the sealing layer 14.

To establish a screening effect with respect to the transfer location between the plug-in contact piece (not illustrated in the FIGURE) and also the sealing layer 14 and the insulating body 6, the second control lining 8 is electrically connected to the first control lining 7 by means of a second metal strap 16. When the high-voltage device 1 is operating, the second control lining 8 is thus at the same electrical potential as the inner conductor 2. Due to the screening the field lines at the foot end 12 adopt a relatively uniform profile. To illustrate this, one field line section 17 is shown in an approximate, schematic manner in the FIGURE by means of a broken line.

A housing 18 gives mechanical strength to the high-voltage device 1. A fastening flange 19 serves to mount the high-voltage device 1 on a component of a high-voltage installation provided for this purpose.

1-10. (canceled)

11. A high-voltage device, comprising:
an inner conductor extending in a longitudinal direction;
an insulating body surrounding said inner conductor along said longitudinal direction;
a plurality of electrically conductive control linings for field control arranged concentrically around said inner conductor and spaced apart from another by insulating layers, said control linings including a first control lining closest to said inner conductor and a second control lining extending axially to a foot end of the high-voltage device beyond said first control lining;
an electrically conductive connection between said inner conductor and said first control lining; and
an electrically conductive connection between said inner conductor and said second control lining.

12. The high-voltage device according to claim 11, wherein said insulating body is formed with a recess having a shape of a truncated cone and opening to the foot end of the high-voltage device, and said second control lining extends axially into a part of the insulating body that surrounds said recess.

13. The high-voltage device according to claim 11, wherein said second control lining is closest to said first control lining.

14. The high-voltage device according to claim 11, which comprises a first metal strap disposed to electrically connect said inner conductor with said first control lining.

15. The high-voltage device according to claim 14, which comprises a second metal strap disposed to electrically connect said first control lining with said second control lining.

16. The high-voltage device according to claim 15, wherein said electrically conductive connection between said second metal strap and said second control lining is solderless connection.

17. The high-voltage device according to claim 12, wherein said recess having the form of the truncated cone is configured to accept a conductor section of a high-voltage cable and the high-voltage device further comprises a plug-in contact for connecting the conductor section to said inner conductor.

18. The high-voltage device according to claim 17, which comprises an electrically insulating sealing layer applied to an inner surface of said recess.

19. The high-voltage device according to claim 18, wherein said second control lining extends axially into a part of said insulating body that surrounds said sealing layer.

20. The high-voltage device according to claim 11, wherein said insulating body comprises resin-impregnated paper.
